(19) United States
(12) Patent Application Publication
(10) Pub. No.: US 2026/0238489 A1
(43) Pub. Date: Aug. 13, 2026

(54) PROXIMITY-BASED TOKENIZED DATA TRANSMISSION FOR INTEROPERABLE DEVICE PLATFORMS

(71) Applicant: PAYPAL, INC., San Jose, CA (US)

(72) Inventors: Vyomesh Sharma, Milpitas, CA (US); Todd Daniel Meijome, Chandler, AZ (US); Thomas Raymond Warne, Phoenix, AZ (US); Adam Lee Beardmore, New Hope, MN (US)

(21) Appl. No.: 19/049,401

(22) Filed: Feb. 10, 2025

(51) Int. Cl. H04L 9/32; H04L 9/08

(52) U.S. Cl. CPC H04L 9/3247; H04L 9/0819

(57) ABSTRACT

A method includes generating a request for a session key from a service. The request is generated based on a first device identifier and an input from a first user, the first user is associated with a first account identifier, and the first account identifier is associated with the service. The method also includes generating a message to a second user device. The message includes the first account identifier, the input, a second account identifier, and a signature generated based on the session key and verifiable by the service with the session key. The method also includes transmitting the message to the second user device while the first user device is within a threshold distance from the second user device and causing the service to modify an account associated with the first account identifier based on the message, in response to transmitting the message to the second user device.

### TECHNICAL FIELD

The present disclosure relates to data transmission between electronic devices and, more particularly, to proximity-based tokenized data transmission for interoperable device platforms.

### BACKGROUND

Electronic devices, such as smartphones, operate at least one of a variety of device platforms, such as an operating system. Many device platforms allow access to short-range communication protocols, such as near-field communication (NFC), to exchange data. However, device platforms vary in the extent to which they allow software application developer access various features of the electronic device, such as a secure element of the device.

### BRIEF DESCRIPTION OF THE DRAWINGS

Certain features of the subject technology are set forth in the appended claims. However, for the purpose of explanation, several embodiments of the subject technology are set forth in the following figures, where like reference numerals refer to the same or similar features in the various figures.

FIG. 1 is a block diagram of an example proximity-based tokenized data transmission system, in accordance with one or more embodiments.

FIG. 2 is a process diagram of an example process performed by the system of FIG. 1, in accordance with one or more embodiments.

FIG. 3 is a process diagram of an example process for peer-to-peer communication between two electronic devices, in accordance with one or more embodiments.

FIG. 4 is a process diagram of an example process for peer-to-peer communication between two electronic devices, in accordance with one or more embodiments.

FIG. 5 is a process diagram of an example process for peer-to-peer communication between two electronic devices, in accordance with one or more embodiments.

FIG. 6 is a flow diagram of an example process for peer-to-peer communication on a sender device, in accordance with one or more embodiments.

FIG. 7 is a flow diagram of an example process for peer-to-peer communication on a verification service device, in accordance with one or more embodiments.

FIG. 8 is a flow diagram of an example process for peer-to-peer communication on a receiver device, in accordance with one or more embodiments.

FIG. 9 is a block diagram of an example computing system, in accordance with one or more embodiments.

### DETAILED DESCRIPTION

The proliferation of mobile devices and wireless communication technologies has changed how individuals exchange information. Near-field communication (NFC) and Bluetooth Low Energy (BLE) are among the most widely adopted proximity-based communication protocols. NFC offers fast and secure communication with minimal power consumption, while BLE extends these capabilities with enhanced range and flexibility. Despite their potential, current applications of these communication protocols often operate within isolated device platforms (e.g., ecosystems, operating systems, etc.), where device compatibility and platform restrictions limit broader interoperability. As consumer demand grows for convenient, secure, and device-agnostic solutions, there is increasing interest in systems that leverage these technologies to create universal frameworks for real-time interaction.

Existing peer-to-peer (P2P) contactless systems face significant limitations that hinder their usability and accessibility. Among these limitations is the lack of interoperability between devices with varying platform capabilities. For instance, certain mobile platforms support advanced features like host card emulation (HCE) for secure NFC data transmission, while others do not, resulting in a fragmented ecosystem. This inconsistency makes it difficult to establish seamless P2P data exchange solutions that work across all devices, leading to reliance on vendor-specific implementations or third-party intermediaries. Additionally, many current systems are designed to operate within tightly controlled environments, leaving little room for flexible communication protocols or adaptive security measures tailored to the capabilities of the devices involved. These challenges are exacerbated by the increasing need for real-time, contactless data transmission solutions that not only enable secure transmission but also maintain compatibility across heterogeneous device platforms. Without a unified approach, users are left to navigate complex and/or incompatible systems, limiting the potential of truly universal P2P experiences.

The systems of the present disclosure address the challenges of interoperability and security in P2P contactless data exchange with a flexible architecture that adapts to the diverse capabilities of mobile electronic devices (e.g., smartphones and smartwatches). By utilizing communication protocols such as NFC and/or BLE for proximity detection and/or data exchange, the system enables compatibility across a broad range of electronic devices, including those without (or that do not provide access to) advanced features such as HCE.

Another technical advantage offered by the present disclosure is dynamic session-based security. A session key, dynamically issued by a payment server, may act as a cryptographic key for secure communication and transaction integrity. The session key is utilized by the sender device to digitally sign the message before transmitting it to the recipient device. This signature effectively tokenizes the message (rather than payment credentials, as in current systems), providing cryptographic assurance of the message's authenticity and integrity. The dynamically issued session key may be issued on a per-interaction basis, eliminating the reliance on static or hardcoded keys (e.g., public and private keys), reducing vulnerabilities and enabling secure, real-time data exchange.

Another technical advantage provided by the present disclosure is decentralized data exchange and centralized validation. The recipient device forwards the signed message to the verification service for verification and processing. Rather than the sender pushing account modifications, the system enables the recipient to pull the account modifications (e.g., to an account balance) from a centralized, trusted verification service using the sender's signed message. The system may support high scalability and enable real-time data exchange in diverse environments without compromising security or usability. The dynamic generation and validation of session keys and signatures by a centralized verification service enables the system to handle multiple simultaneous exchanges efficiently.

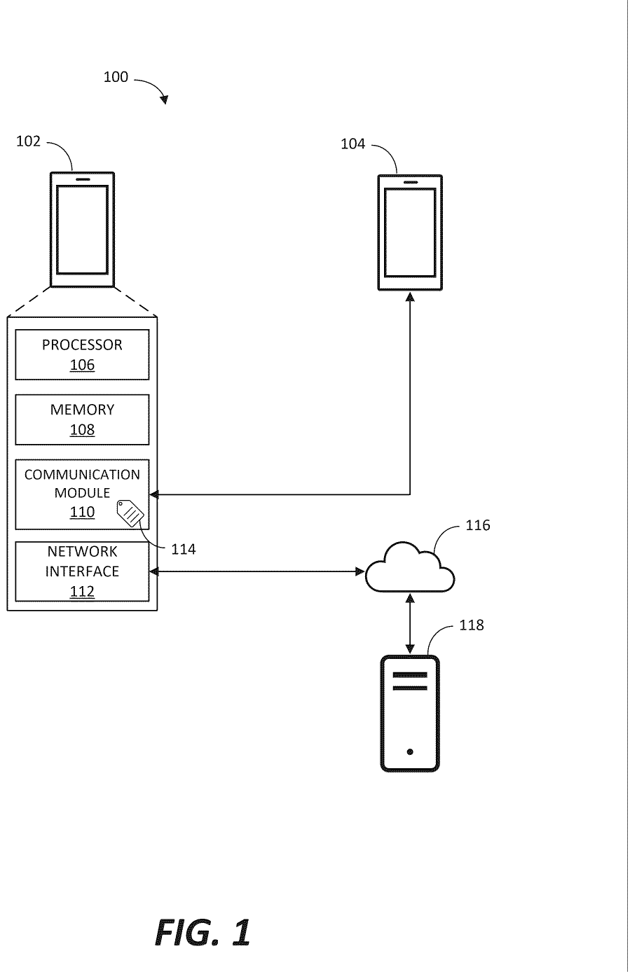

Referring now to the drawings, wherein like numerals refer to the same or similar features in the various figures, FIG. 1 is a block diagram of an example proximity-based tokenized data transmission system 100, in accordance with one or more embodiments. Not all of the depicted components may be used in all embodiments, and one or more embodiments may include additional, fewer, or different components than those shown in the figure. Variations in the arrangement and type of components may be made without departing from the spirit or scope of the claims as set forth herein. Furthermore, the modules described with respect to the system 100 are used for convenience to refer to functionality that the system 100 is configured to perform by way of one or more components of the system 100 (e.g., computer-readable instructions in memory).

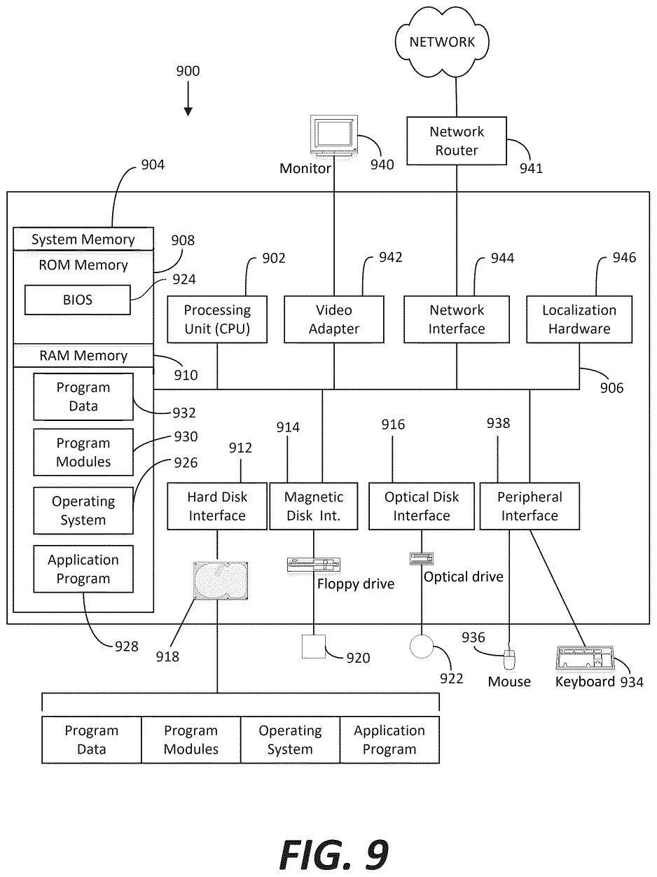

The system 100 may include a user device 102 associated with a first user. The user device 102 may be a computing device such as a laptop computer, desktop computer, tablet, smartphone, smartwatch, or any other electronic device, such as a device having some or all of the components described with respect to FIG. 9. The network interface 112 (e.g., network interface card, cellular modem, etc.) enables the user device 102 to be in electronic communication with a server 118 via a network 116. The user device 102 may include one or more software applications, which may be stored in memory 108 and run by the processor 106 in a foreground state (e.g., open and/or presented on the user device 102) and/or background state (e.g., closed and/or not presented on the user device 102). The software applications may be configured to facilitate data exchange, receive session keys, generate digital signatures, and/or the like. The communication module 110 of the user device 102 may be configured (e.g., by a software application) to read and/or write data in one or more communication protocols, including short-range communication protocols (e.g., NFC) and/or long-range communication protocols (e.g., Wi-Fi Direct). The communication module 110 may be configured to read from, write to, and/or emulate a virtual tag 114 such as an NFC tag, which may be a passive marker that stores and/or transmits data when in close proximity with an NFC-enabled device.

The system 100 may also include a user device 104 associated with a second user. The user device 104 may be an electronic device similar to the user device 102 configured to communicate in the same and/or different communication protocols. For example, the communication module 110 may be configured to utilize HCE while the user device 104 may not. The user device 104 may be in proximity to the user device 102 to write to and/or read from the tag 114. For example, the user device 104 may be up to four centimeters from the user device 102 to read the tag 114 with NFC, allowing users to effectively “tap” their devices together to exchange data.

The server 118 may be an electronic device that includes components described with respect to FIG. 9. The server 118 may host (or may be in network communication with another server that hosts) a verification service such as a web application, web site, API endpoint, and/or the like. The verification service may be configured to maintain user accounts, modify user accounts (e.g., account attributes, balances, etc.), generate session keys, validate digital signatures, etc. In some embodiments, the server 118 may be multiple servers (e.g., on a cloud environment) across which the verification service may be operating. The verification service may be a centralized location for dynamically generating session keys and/or validating signatures, enabling secure data exchanges between user device 102 and user device 104.

In operation, when a user attempts to use the user device 102 to exchange data with user device 104, the processor 106 may receive input from a user and the communication module 110 may generate a cryptographically signed message. To generate the signed message, the user device 102 may generate a message based on the input and use a session key from the server 118 to generate a digital signature based on the message, which together form a signed message. To send the signed message to the user device 104, in some embodiments, the user device 102 may generate virtual tag 114 and write the signed message to the tag 114 for the user device 104 to read when the user device 104 is within a threshold distance of the user device 102. When the user device 104 has the signed message, the user device 104 may communicate with the server 118 to request a modification to one or more user accounts specified by the message and in a manner specified by the message (e.g., based on the user input). For example, the user device 104 may request that the server 118 transfer a specified part of the account balance (e.g., input by the user) from the account of user device 102 to the account of user device 104). In some embodiments, the signed message may be readable by the user device 104 meaning, for example, that the user device 104 knows what the user account and the modification are as specified by the message. In such embodiments, the server 118 can confirm that the request is approved by the user device 102 by verifying the digital signature.

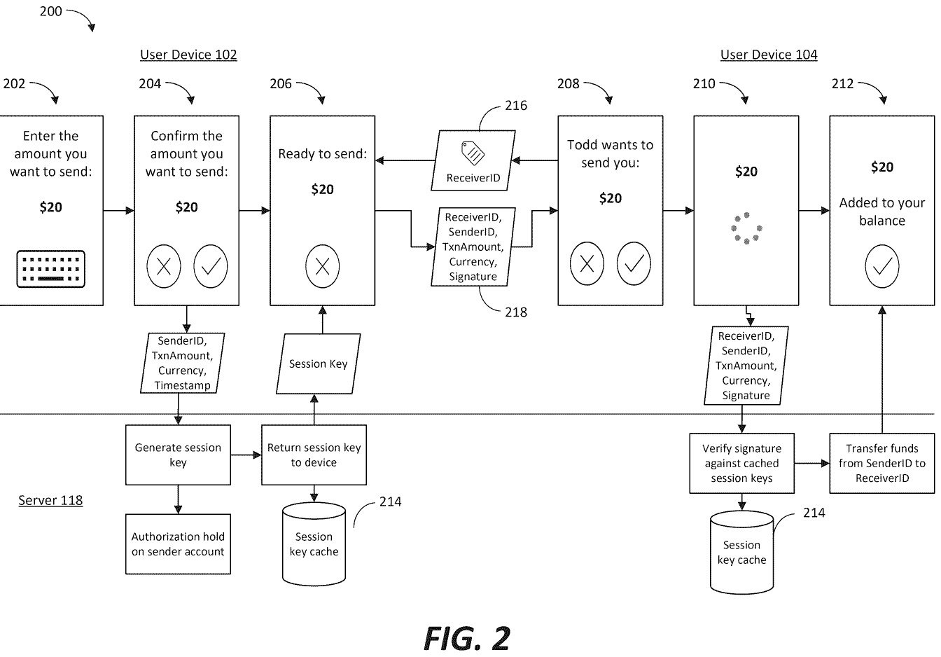

FIG. 2 is a process diagram of an example process 200 performed by the example system 100, in accordance with one or more embodiments. For explanatory purposes, FIG. 2 is described herein with reference to the system 100 of FIG. 1, and thus the process 200 may be a computer-implemented method. However, this is merely illustrative, and features of the system 100 may be performed by any other system for implementing the subject technology. Additionally, for explanatory purposes, the operations of the process 200 are described herein as occurring sequentially or linearly. However, multiple operations of the process 200 may occur in parallel. The operations of the process 200 need not be performed in the order shown, and one or more operations of the process 200 need not be performed or can be replaced by other operations.

The example process 200 involves data exchange, which may be a P2P contactless transaction between the user device 102 and user device 104, where the user device 102 is the sender and the user device 104 is the recipient. It should be understood, however, that use of the system 100 for payments is merely an example and that other applications for the system 100 are possible.

At operation 202, the sender device (e.g., user device 102) receives an input. The sender device may include a touch screen or other input device by which the sender device may solicit and the user of the sender device may provide an amount (e.g., numerical value) to transfer to the user of the receiver device (e.g., user device 104). The transfer may occur by way of a deduction in balance of an account of the user of the sender device and an increase in balance of an account of the user of the receiver device. In some embodiments, the input is received via an application running in the foreground of the sender device.

At operation 204, the sender device outputs a request for confirmation to, and receives a confirmation from, the user. The confirmation may be an indication from the user confirming the transaction, such as a button press on a touch screen. In some embodiments, receiving the indication causes the sender device to request a session key from the verification service (e.g., running on the server 118).

After receiving the confirmation, the sender device requests a session key from the verification service. The request may include preliminary information for key generation. Preliminary information may include (e.g., be generated based on) the sender's account identifier (or any other identifier associated with the sender's account and/or device), the amount (e.g., input by the user at operation 202), and/or any other information related to the transaction. For example, the session key request shown in the figure includes the sender's account identifier, the amount, a relevant currency, and/or a current timestamp.

After receiving the request, the verification service may generate (e.g., create, access, retrieve, etc.) the session key. The server 118 may use the request from the sender device as input to a cryptographic hash function or key derivation function (KDF) to generate the session key. The cryptographic hash function may be, for example, SHA-256 (Secure Hash Algorithm 256) or MD-5 (Message-Digest Algorithm 5). The hash may be used in, for example, elliptic curve cryptography (ECC) for generating a digital signature. The KDF may be, for example, HKDF (HMAC-based Key Derivation Function), PBKDF2 (Password-Based Key Derivation Function 2), and/or SHA-based (Secure Hash Algorithm) methods.

In embodiments where the session key is based on specific parameters, such as the sender's account identifier and the amount, these inputs may first be normalized and/or encoded so that they are in a consistent format. For example, the account identifier may be hashed to anonymize sensitive user data before being used in the key generation process. Similarly, the transaction amount may be converted into a fixed precision format. These inputs may then be combined (e.g., concatenated) with a timestamp, which maintains the session key's uniqueness across different transactions, even if other parameters remain the same. The combined inputs may then be hashed with a cryptographic hash function (e.g., SHA-256). The resulting session key is a unique, time-sensitive, cryptographically secure key that is bound to the specific transaction context.

In some embodiments, the verification service also incorporates a server-side secret or root key as part of the key generation process. This root key is securely stored and not shared outside the server. Using a cryptographic hash function or a KDF, such as HKDF, the verification service may combine the input parameters with the root key (as the HMAC key) to derive the session key. The resulting session key is unique to the specific transaction, tied to the input parameters, and secured so that the session key cannot be forged or recreated without access to the root key.

In some embodiments, the verification service may include a random nonce and/or salt value in the key generation process. The nonce, generated for each transaction, helps keep the session key unpredictable and resistant to cryptographic attacks. The salt value, combined with the timestamp and other data from the request, helps prevent even identical input parameters from resulting in the same session keys in separate transactions.

In some embodiments, the session key may be generated uniquely for a particular transaction and/or may include an expiration.

In some embodiments, the verification service may place an authorization hold on the account of the sender in the amount specified by the request. The authorization hold may be placed on the account balance, if one is available, and/or with other providers (e.g., payment providers) linked to the sender's account.

In some embodiments, the verification service may perform multiple instances of the process 200 at the same time for different users and/or transactions, separately or in parallel with the sender. To do so, the server 118 can receive key generation requests from multiple user devices.

At operation 206, once the session key is generated, the verification service returns the session key to the sender device. In some embodiments, the verification service also stores a copy of the session key in a session key cache 214, which may include the associated transaction metadata, to facilitate subsequent verification of digital signatures. When the sender device receives the session key, the sender device may generate a message to send to the receiver device

To generate the message, the sender device also receives the receiver's account identifier 216 from the receiver device. The receiver device may broadcast (e.g., advertise via a short-and/or long-range communication protocol) the receiver's account identifier 216 (or any other identifier associated with the receiver's account and/or device). For example, an application running in the foreground or background of the receiver device may cause its NFC component to periodically transmit the receiver's account identifier 216. When the receiver device is brought within a threshold range of the sender device (e.g., the sender and receiver tap their devices together), the receiver device may broadcast and the sender device may listen for and receive the receiver's account identifier 216.

Once the sender device receives the session key and the receiver's account identifier 216, the sender device generates a signed message to send to the receiver device. This process involves assembling the set of message contents, signing message contents using the session key, and transmitting the signed message.

To assemble the message contents, the sender device may collect and/or format the transaction data. This data may include the sender's account identifier, the receiver's account identifier, the amount, and/or a timestamp. The sender device may also include additional metadata, such as a transaction identifier or device-specific information. In some embodiments, the message contents may be encrypted.

The sender device digitally signs the message using the session key. To generate a digital signature, the sender device utilizes a cryptographic signing algorithm, such as HMAC (Hash-based Message Authentication Code) or a digital signature algorithm (e.g., ECDSA or RSA). For example, the sender device first generates a hash of the message contents using a cryptographic hash function (e.g., SHA-256) to transform the message contents into a hash. Once the hash is generated, the sender device encrypts the hash using the session key, which acts as the encryption key in algorithms such as HMAC, RSA, or ECDSA.

The signed message is then constructed by appending the generated signature to the original message contents. This signed message 218 may then include the sender's account identifier, receiver's account identifier, transaction amount, timestamp, and signature. The sender device may encode and/or encrypt the signed message, depending on the security requirements and the receiver device's capabilities.

Finally, the sender device transmits the signed message 218 to the receiver device using a short-range communication protocol such as NFC, BLE, or P2P Wi-Fi. In some embodiments, transmitting the signed message 218 includes writing the signed message onto a tag (e.g., an NFC tag), which the receiver device can read to obtain the signed message. In some embodiments, the tag may be emulated by the sender device, which the receiver device can read to obtain the signed message. In some embodiments, the tag may be emulated by the receiver device, and the receiver can obtain the message directly from the tag after the message is written to the tag by the sender.

At operation 208, the receiver device receives the signed message 218. Receiving the signed message 218 includes the receiver device opening an application to a foreground of the receiver device. In some embodiments, the sender device may cause the receiver device to open the application to the foreground (e.g., by sending a command to open the application). In some embodiments, the user of the receiver device can accept or reject the message (e.g., via the application). The receiver device may proceed with the remaining operations in response to accepting the message or may discard the message in response to rejecting the message.

At operation 210, the receiver device, upon receiving the message, can verify the message with the verification service. Verifying the message may include the receiver device forwarding the message, including the digital signature, to the verification service to confirm the authenticity and integrity of the digital signature and thus the message. The verification service uses the session key stored in the session key cache 214 at operation 206 to validate the digital signature, confirming that the message was not tampered with and originated from the sender device.

To verify the authenticity of a digitally signed message, the verification service performs a validation process. The validation process may include generating a hash of the received message, encrypting the hash, and comparing the resulting encrypted hash with the digital signature. For instance, when the verification service receives the signed message from the receiver device, the verification generates a hash based on the message and encrypts the hash with the session key, which was previous generated at operation 206 (e.g., stored in session key cache 214). The verification service then compares the encrypted hash with the signature. If they match, the signature is considered valid, indicating that the message was not altered during transmission and was signed using the correct session key. Additionally, the validation confirms that the message originates from the sender and is tied to the specific transaction session. Overall, the validated signature serves as cryptographic proof that the sender authorized the transaction using the session key, improving the integrity of the operation.

Alternatively, in some embodiments, the validation process may include decrypting the signature using the session key and comparing the resulting hash with a hash of the received message generated by the verification service. For instance, when the verification service receives the signed message from the receiver device, the verification service extracts the message content and the accompanying digital signature. The verification service then decrypts the signature using the session key, which was previously generated at operation 206 (e.g., stored in session key cache 214). The decryption process reverses the encryption process performed during the operation 206, revealing the original hash of the message contents as generated by the sender device. The verification service also generates its own hash of the message contents. The verification service then compares the decrypted hash from the signature with the service-generated hash. If the two hashes match, the signature is considered valid, indicating that the message was not altered during transmission and was signed using the correct session key.

At operation 212, once the signature is validated, the verification service uses the message contents to carry out the transaction. In carrying out the transaction, the verification service may verify the transaction details, such as the sender's account identifier, receiver's account identifier, and/or amount. The verification service may also perform additional verification of the transaction itself such as confirming that the transaction is not expired (e.g., the session key is not expired), whether the sender has sufficient funds (e.g., in the authorization hold from operation 204), and/or the like. Carrying out the transaction may include decreasing a balance of the sender's account by the amount specified in the message and increasing a balance of the receiver's account by the amount specified in the message.

If the signature cannot be validated or the transaction otherwise cannot be performed, the receiver's request to perform a transaction according to the message may be rejected and any authorization holds on the sender's account may be released.

It should be understood that, while an example process for digital signature generation and validation is described with respect to process 200, the system may employ any other digital signature generation algorithm that uses or can use a symmetric encryption key (e.g., Keyed-Hash Message Authentication Code).

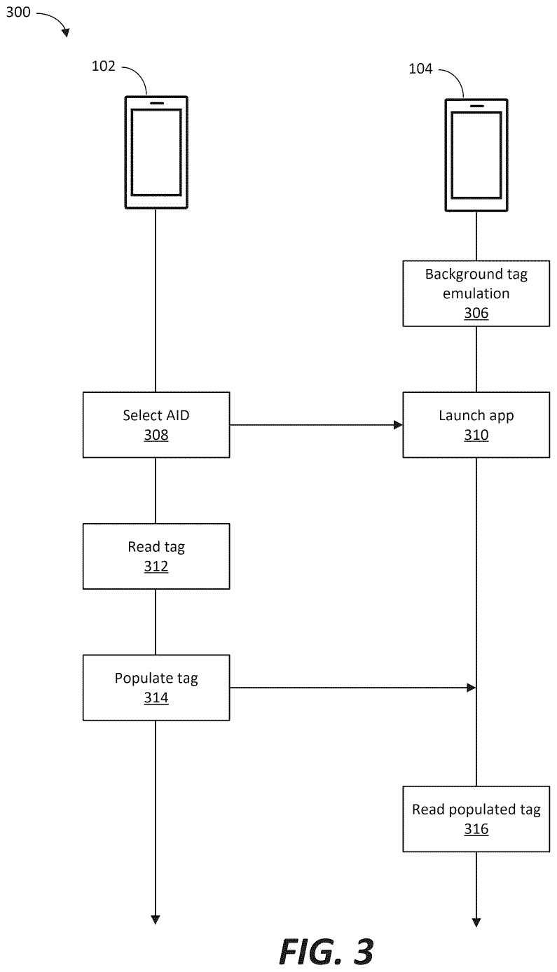

FIG. 3 is a process diagram of an example process 300 for P2P communication between two electronic devices, in accordance with one or more embodiments. For explanatory purposes, the figure is described with reference to the system 100 of FIG. 1 and thus the process 300 may be a computer-implemented method. However, this is merely illustrative, and features of the system 100 may be performed by any other system for implementing the subject technology. Additionally, for explanatory purposes, the operations of the process 300 are described herein as occurring sequentially or linearly. However, multiple operations of the process 300 may occur in parallel. The operations of the process 300 need not be performed in the order shown, and one or more operations of the process 300 need not be performed or can be replaced by other operations.

In the process 300, the user device 102 is the sender and is configured to utilize an NFC interface. The user device 104 is the receiver and is configured to utilize HCE. It should be understood that these configurations are merely an example and that other configurations are possible. It should also be understood that the process 300 may be used to exchange any kind of data and that transaction data described herein with respect to process 300 is merely an example.

At operation 306, the receiver device's background application protocol data unit (APDU) service is in a “receive mode” and populates a tag with the receiver's identifier (e.g., account identifier and/or device identifier). In this mode, the receiver emulates an NFC tag (e.g., card, chip, marker, etc.), creating a virtual tag that nearby devices can read. The APDU service may prepare this tag by encoding the receiver's identifier into a format that conforms to, for example, the NFC data exchange format (NDEF) or JavaScript Object Notation (JSON). The receiver identifier may be stored in (e.g., virtually written to) the tag and made available to NFC-capable devices that initiate communication.

When another device (e.g., the sender device) comes into proximity and establishes an NFC connection, the receiver device's emulated tag may respond to queries with the populated receiver identifier. This operation allows the receiver device to act passively, waiting for an NFC-enabled device to interact with it.

At operation 308, the sender device, which uses NFC to communicate, initiates the interaction by selecting an application identifier (AID) corresponding to the receiver device's HCE application. The AID is a unique identifier associated with a specific app or service running on the receiver device and used to facilitate the data exchange (e.g., a transaction). The sender device may select the AID from a list of supported services based on its intended operation, such as initiating a transaction.

The selection process may include the sender device transmitting an “AID selection” APDU command over the NFC channel. The receiver device's APDU service, listening for such commands, identifies the selected AID as its own and activates the corresponding application. This prepares the receiver device to handle subsequent data exchanges related to the current session.

At operation 310, upon recognizing the AID selection from the sender device, the receiver device transitions from passive emulation to actively launching (e.g., into a foreground) a corresponding application (e.g., payment application) or service. This may include signaling the appropriate application or service to open and transition into a “receive flow” state. In this state, the application prepares to process incoming data related to the subsequent data exchange (e.g., transaction). In some embodiments, the application may display a user interface on the receiver device, allowing the receiver to monitor and/or confirm the progress of the exchange. By the operation, the receiver device is active and ready to exchange data with the sender device.

At operation 312, the sender device uses its NFC capabilities to read the receiver device's emulated tag. This involves the sender device initiating an NFC communication session and sending a command to access the tag's data. The sender device's NFC reader parses the tag to extract the receiver identifier. The sender device then uses the receiver identifier to request a session key from the server 118. The sender device may also temporarily store the receiver identifier and use it in constructing the message and/or subsequent messages. The sender device may also validate the format and/or integrity of the receiver identifier to confirm that it aligns with the expected structure for further processing.

At operation 314, the sender device prepares a message to write back to the receiver device's virtual tag. The message may include content such as the sender identifier, receiver identifier, transaction details (e.g., payment amount), a timestamp, and the digital signature generated by the sender device based on the session key. The message may be structured into a format (e.g., NDEF) for compatibility with NFC communication protocols.

The sender device writes the message onto the receiver device's virtual tag. The writing process may include issuing commands to overwrite the previous contents of the tag with the message. Alternatively, the writing process may include issuing commands to add the message contents to the receiver identifier still on the tag. At this point, the receiver device's tag holds the complete message, which may include the details necessary for the receiver device to proceed with the transaction.

At operation 316, after the sender device populates the receiver device's tag with the message, the receiver device reads the updated tag. The receiver device's application, now in a “receive flow,” extracts the message data, including the sender identifier, transaction specifics (e.g., amount), and digital signature.

The receiver device also prepares a request to the server 118. The request may include the extracted message data and the digital signature, which the server 118 verifies using the session key. The receiver device transmits the request to the server 118, initiating the server-side processing of the transaction. Once the server validates the signature and processes the transaction, the funds are transferred and/or the transaction is completed as specified.

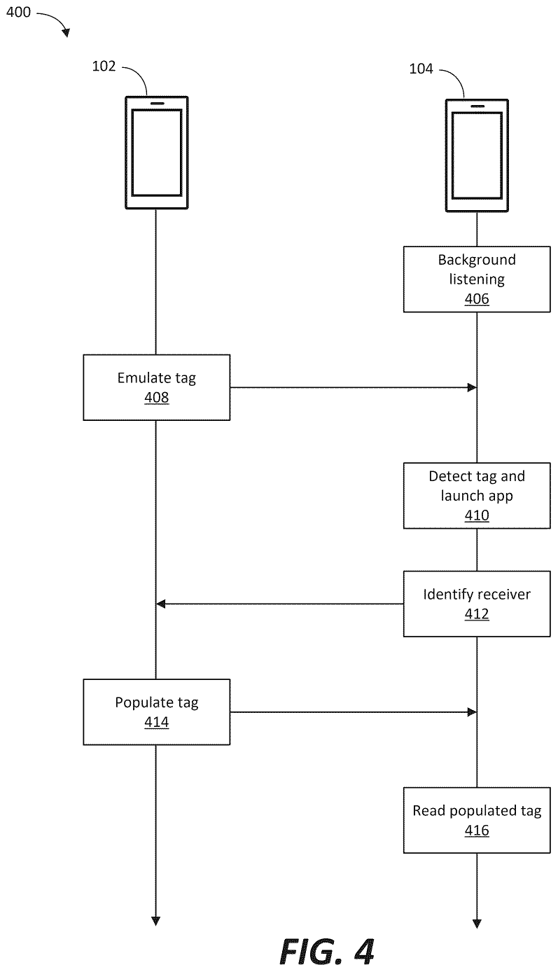

FIG. 4 is a process diagram of an example process 400 for P2P communication between two electronic devices, in accordance with one or more embodiments. For explanatory purposes, the figure is described with reference to the system 100 of FIG. 1 and thus the process 400 may be a computer-implemented method. However, this is merely illustrative, and features of the system 100 may be performed by any other system for implementing the subject technology. Additionally, for explanatory purposes, the operations of the process 400 are described herein as occurring sequentially or linearly. However, multiple operations of the process 400 may occur in parallel. The operations of the process 400 need not be performed in the order shown, and one or more operations of the process 400 need not be performed or can be replaced by other operations.

In the process 400, the user device 102 is the sender and is configured to utilize HCE. The user device 104 is the receiver and is configured to utilize NFC. It should be understood that these configurations are merely an example and that other configurations are possible. It should also be understood that the process 400 may be used to exchange any kind of data and that transaction data described herein with respect to process 400 is merely an example.

At operation 406, the receiver device initiates its background NFC service to listen for tag interactions. The service may operate in an “interop tag dispatch” mode, which allows the receiver device to detect and/or interact with emulated tags from nearby devices. The “interop tag dispatch” mode causes the service to scan for an AID that indicates the emulating device is in send mode. This prevents a sender's emulating device from detecting its own tag in the case where the receiver device includes HCE. In some embodiments, the service listens for an AID that is different from the AID of operation 306. The service passively waits for an NFC tag to come into proximity with the receiver device.

At operation 408, the sender device, using HCE, toggles its APDU service into a “send mode”. In this mode, the sender device emulates a tag (e.g., NFC tag) by generating a virtual representation of the tag. The emulated tag may include basic information initially, such as metadata for the receiver device to identify and interact with it. The emulated tag may also include an AID, which may be different from the AID of operation 306. For example, operation 306 uses the default AID for presenting receiver account information and operation 408 uses an “interop” AID for facilitating sending to devices that do not support HCE. The AIDs of operation 306 and operation 408 may be distinct to prevent the sending device from detecting its own receiver tag and interfering with establishing a link in the interop case.

At operation 410, when the receiver device's NFC reader detects the sender device's virtual tag, the receiver device launches an application (e.g., on a foreground of the receiver device) to facilitate the message exchange. The receiver device may place the application into a “receive flow” state. This state enables the application to actively process messages (e.g., transaction-related data), preparing to retrieve additional information from the sender device's virtual tag. The receiver device's application may confirm the AID selection with the sender device's HCE service, confirming compatibility before proceeding with the next steps of the exchange.

The application launched may be based on an AID. The receiver device processes (e.g., reads) the virtual tag to identify an AID, which indicates the specific application or service managing the interaction. The receiver device may recognize the AID and use this information to launch the appropriate application or service.

At operation 412, once the receiver device's application is in a “receive flow”, the receiver device communicates its receiver identifier to the sender device. This may include the receiver device's NFC interface writing the receiver identifier to the sender device's emulated NFC tag. The receiver identifier may be encoded in a predefined format such as NDEF for compatibility with the sender device's HCE service. The sender device's APDU service, still in “send mode”, captures the receiver identifier and prepares to incorporate it into the message by, for example, requesting a session key from the server 118.

At operation 414, after receiving the receiver identifier, the sender device uses its APDU service to assemble the complete message. The message includes the receiver identifier provided by the receiver, the sender identifier, the transaction details (e.g., an amount), a timestamp, and a digital signature generated using the session key.

The sender device's HCE service may generate the digital signature by hashing the transaction details and encrypting the hash with the session key. The message contents may be formatted into an NDEF structure or a similar format suitable for NFC communication. The message may be encrypted with a private key of the sender device. Once to ready transmit, the sender device's virtual tag is updated (e.g., by populating the tag) to store the message, making it available for the receiver device to access.

At operation 416, the receiver device, still in a “receive flow”, utilizes its NFC interface to read the message stored in the sender device's virtual tag. The receiver device may extract (e.g., decrypt and read) from the message the receiver identifier, sender identifier, transaction details, and digital signature. The receiver device's application may process the extracted data, verifying its format and content to confirm it is complete and valid.

After the message has been successfully read, the sender device may toggle its APDU service back to “receive mode”, allowing it to interact further if necessary, such as for acknowledgment messages or follow-up operations. Meanwhile, the receiver device uses the retrieved message to prepare and send a request to the server 118 to facilitate the transaction. The request includes the transaction information and the digital signature, which the server 118 validates using the session key before completing the transaction.

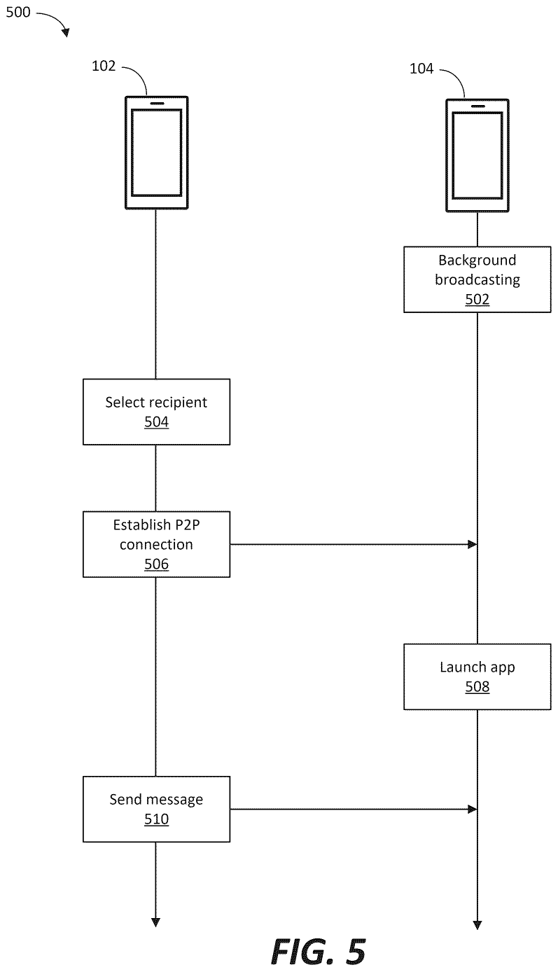

FIG. 5 is a process diagram of an example process 500 for P2P communication between two electronic devices, in accordance with one or more embodiments. For explanatory purposes, the figure is described with reference to the system 100 of FIG. 1 and thus the process 500 may be a computer-implemented method. However, this is merely illustrative, and features of the system 100 may be performed by any other system for implementing the subject technology. Additionally, for explanatory purposes, the operations of the process 500 are described herein as occurring sequentially or linearly. However, multiple operations of the process 500 may occur in parallel. The operations of the process 500 need not be performed in the order shown, and one or more operations of the process 500 need not be performed or can be replaced by other operations.

In the process 500, the user device 102 is the sender, and the user device 104 is the receiver. Neither user device 102 nor user device 104 are configured to use HCE. It should be understood that these configurations are merely an example and that other configurations are possible. It should also be understood that the process 500 may be used to exchange any kind of data and that transaction data described herein with respect to process 500 is merely an example.

At operation 502, the receiver device uses a short-range communication protocol (e.g., Bluetooth Low Energy (BLE) beaconing) to broadcast its identifier (e.g., receiver identifier). In BLE beaconing embodiments, the receiver device may act as a BLE peripheral, periodically (e.g., every second) transmitting advertising packets that include its receiver identifier. These packets may include fields such as a universally unique identifier (UUID), values to distinguish devices or contexts, and/or metadata like device name or battery status. In other embodiments, the receiver device may create a discoverable session (e.g., using Wi-Fi Direct or Bluetooth) making the receiver identifier available in a peer-discovery phase. The receiver identifier may be part of a service advertisement, such as a service name or custom identifier, presented alongside device details to facilitate recognition by nearby senders. The sender device may use the receiver identifier to request a session key from the server 118.

At operation 504, the sender device scans the environment for broadcast signals from nearby receiver devices. In the case of BLE beaconing, the sender device may function as a central device, detecting advertising packets within range. The sender may use signal strength (e.g., measured as received signal strength indicator (RSSI)) to estimate proximity and prioritize nearby devices. The application on the sender device may display a list of detected receiver device, showing identifiers like device names and/or receiver identifiers (extracted from the advertisements), which may be arranged based on proximity. The user may then select the desired recipient. Alternatively, the sender device may automatically select the closest device (e.g., the device corresponding to the stronger signal). Once the sender device selects the desired recipient (manually or automatically), the application may capture the receiver identifier.

At operation 506, after the sender device selects the recipient device, the devices establish a P2P connection using a short-to long-range communication protocol. In the case of BLE, the sender device may initiate a connection request to the receiver device. This process may begin with the sender device scanning for the receiver device's advertising packets, identifying the receiver identifier, and transmitting a connection request to the receiver device. The receiver device may accept the connection request, establishing a dedicated communication channel.

Alternatively, the sender device uses Wi-Fi Direct or Bluetooth to initiate a P2P connection. After discovering the receiver, the sender device may exchange connection parameters, such as encryption keys, to establish a secure and private connection. This handshake process facilitates pairing the devices for further data exchange and authenticating and encrypting the connection.

At operation 508, once the P2P connection is established, the receiver device launches its application (e.g., to the foreground). This may occur automatically through an event triggered by the connection or manually by the user opening the application. For example, the connection may trigger the application on the receiver device to listen for incoming data from the sender over the established connection. The application on the receiver device may listen for messages from the sender device on the P2P connection.

At operation 510, with the P2P connection active and the receiver device's application ready, the sender device transmits the message via the P2P connection. The message may include the sender identifier, receiver identifier (e.g., acquired during the selection process), transaction details (e.g., amount), a timestamp, and/or a digital signature (e.g., generated by the sender with the session key).

The application on the receiver device may process the message, verifying its format and/or extracting the message contents. The application on the receiver device may use the extracted contents including the digital signature to generate a request to the server 118. The request may include the information for the server 118 to verify the sender's authorization (e.g., digital signature) and complete the transaction (e.g., identifiers and transaction information).

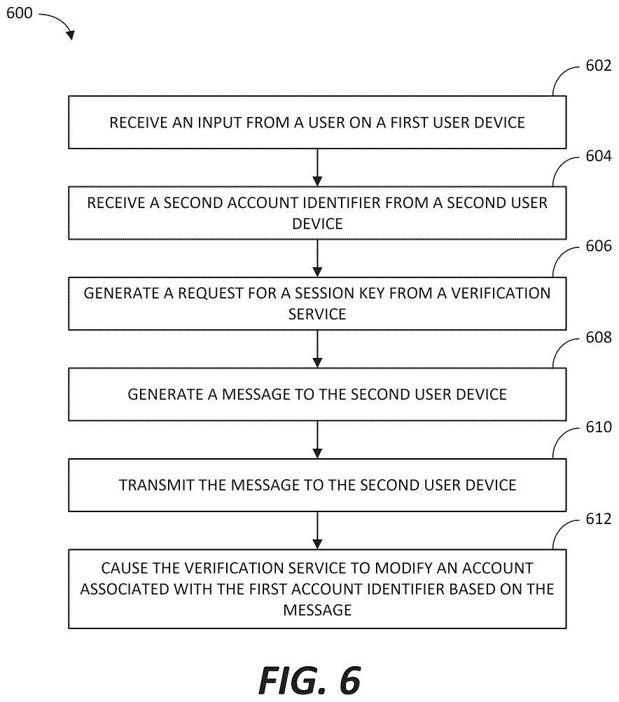

FIG. 6 is a flow diagram of an example process 600 for P2P communication on a sender device, in accordance with one or more embodiments. For explanatory purposes, the figure is described with reference to the system 100 of FIG. 1 and thus the process 600 may be a computer-implemented method. However, this is merely illustrative, and features of the system 100 may be performed by any other system for implementing the subject technology. Additionally, for explanatory purposes, the operations of the process 600 are described herein as occurring sequentially or linearly. However, multiple operations of the process 600 may occur in parallel. The operations of the process 600 need not be performed in the order shown, and one or more operations of the process 600 need not be performed or can be replaced by other operations.

At operation 602, the sender device (e.g., user device 102 or “first user device”) receives an input from a user. The input may be information (e.g., an amount) the user would like to send to a receiver device (e.g., user device 104 or “second user device”). The input may also be information indicating that the sender device may send a message to the receiver device (e.g., a confirmation).

The sender device may include an application running in a foreground of the sender device. The application may be associated with the first user account identifier, which may be associated with the verification service (e.g., on the server 118). Similarly, the receiver device may include an application running in a background or foreground of the receiver device. The application may be associated with the second user account identifier which may also be associated with the verification service.

At operation 604, the sender device receives the second account identifier from the receiver device. The sender device may receive the second account identifier in response to a distance between the sender device and the receiver device being within a threshold distance. For example, the sender and receiver may tap their devices together or the sender may select the nearby receiver on an application on the sender device. The threshold distance may be predetermined based on the communication protocol used to receive the second account identifier (e.g., <10 cm in the case of NFC or <2 m in the case of BLE beacon). The sender device may determine that the receiver device is within the threshold distance based on a strength of a signal emitted from the receiver device and received by the sender device. For example, an application running in a foreground of the sender device may detect a signal generated by another application running in a background of the receiver device.

At operation 606, the sender device generates a request for a session key from the verification service. In some embodiments, the request is generated based on a first device identifier of the first user device and an input received at the first user device from a first user. For example, the request may include the first account identifier and the user input. The session key may be unique to the sender, the sender device, and/or a data exchange session (e.g., an instance of the process 600). In some embodiments, the session key may be a unique string, such as a UUID or hash of the request from the sender device. The verification service may generate the session key and return it the sender device in response to the session key request. The session key may include a cryptographic key configured to allow secure transmission of information from the sender device to a receiver device.

At operation 608, the sender device generates a message to the receiver device. The message may include message content such as the first account identifier (e.g., sender identifier), the second account identifier (e.g., receiver identifier), and/or the user input. The message may also include a digital signature. The digital signature may be generated based on the session key, such as by hashing the message content and encrypting hashed message content with the session key. As a result, the signature may include a cryptographic representation of the message to allow secure verification of the message, and the signature may be verifiable by the verification service with the session key to confirm that the message was generated by the first user device. The session key itself may be withheld from devices are that are not the sender device, such as the receiver device. The message may be generated in response to receiving the second account identifier.

At operation 610, the sender device sends (e.g., transmits) the message to the receiver device. In some embodiments, sending the message includes using a first communication protocol (e.g., HCE) to populate a local and/or remote virtual tag (e.g., an emulated physical tag) with the message. The local virtual tag may be on the sender device and the remote virtual tag may be on the receiver device. In some embodiments, sending the message includes using the first communication protocol to populate a physical tag with the message. The message may then be read from the local and/or remote virtual tag and/or physical tag by the receiver device with a second communication protocol (e.g., NFC). In some embodiments, the sender device may transmit the message to the receiver device while the sender device is within a threshold distance from the receiver device, as described above in operation 604.

In some embodiments, transmitting the message to the receiver device causes the application on the receiver device to run in a foreground of the receiver device.

In some embodiments, the first user device receives the second account identifier via a first communication protocol and sends the message via a second communication protocol, different from the first communication protocol.

At operation 612, the sender device causes the verification service to modify an account associated with the first account identifier. For example, transmitting the message may cause the receiver device to activate (e.g., launch to a foreground) an application to process the message. The application on the receiver device may process the message by using the message to generate a request to the verification service for modifying an account associated with the first account identifier and/or an account associated with the second account identifier. The modification of the account(s) may be based on at least part of the message (e.g., the input from the user of the sender device).

After sending the message to the receiver device, the sender device may receive from the verification service an indication that accounts associated with the first account identifier and/or the second account identifier have been modified in accordance with the message (e.g., the input from the user of the sender device).

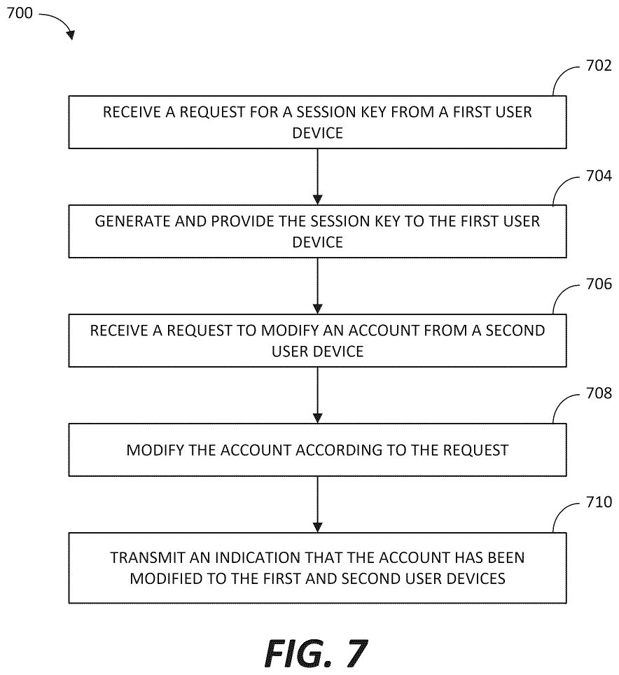

FIG. 7 is a flow diagram of an example process 700 for P2P communication on a verification service device, in accordance with one or more embodiments. For explanatory purposes, the figure is described with reference to the system 100 of FIG. 1 and thus the process 700 may be a computer-implemented method. However, this is merely illustrative, and features of the system 100 may be performed by any other system for implementing the subject technology. Additionally, for explanatory purposes, the operations of the process 700 are described herein as occurring sequentially or linearly. However, multiple operations of the process 700 may occur in parallel. The operations of the process 700 need not be performed in the order shown, and one or more operations of the process 700 need not be performed or can be replaced by other operations.

At operation 702, the verification service device (e.g., the server 118) receives a request for a session key from a sender device (e.g., user device 102). The session key may be a cryptographic key unique to a particular instance of communication between the sender device and receiver device, to the parties of the communication, to a current login session of the sender on an application on the sender device, and/or the like.

At operation 704, after receiving the request, the verification service device generates the session key. The session key may be generated based on one or more parameters such as the first user account, second user account, and/or the like. In some embodiments, the session key may be a random unique key.

In some embodiments, the session key may be cached (e.g., session key cache 214). The session key may be cached with the data used to generate the session key. The session key may also or instead be cached with an expiration so that the communication must take place within a particular time period.

Once the key is generated, the verification service device provides the session key to the sender device. The sender device may use the session key to generate a digital signature for a message to communicate to the receiver device.

At operation 706, the verification service device receives a request from the receiver device. The request may be to perform an action based on the signed message that the receiver device received from the sender device (e.g., via the virtual tag emulated by the receiver device and written to by the sender device). The action may include verifying the authenticity and integrity of the message. Because the verification service device cached the session key and the receiver device does not have the session key, the receiver device relies on the verification service device to verify the authenticity and integrity of the message. To perform the verification, the verification service device may use the session key (generated at operation 704) to generate a hash of the message. The verification service device may encrypt the hashed message (e.g., with the session key) to compare against the digital signature. If the signatures match, then the message content may be deemed unaltered and from the sender device since the sender device is the only recipient of the session key.

At operation 708, the action may also include modifying one or more accounts associated with the verification service based on the message. The modification may include updating an attribute of one or more accounts. For example, the modification may be to reduce a balance in the first user account and increase a balance in the second user account by an amount specified in the message.

At operation 710, after successfully performing the action, the verification service device transmits an indication of success to the receiver device and/or the sender device. The indication may be that an account has been modified according to the message. For example, the verification service device may send an alert to the sender device of the balance (e.g., total value) of the first user account.

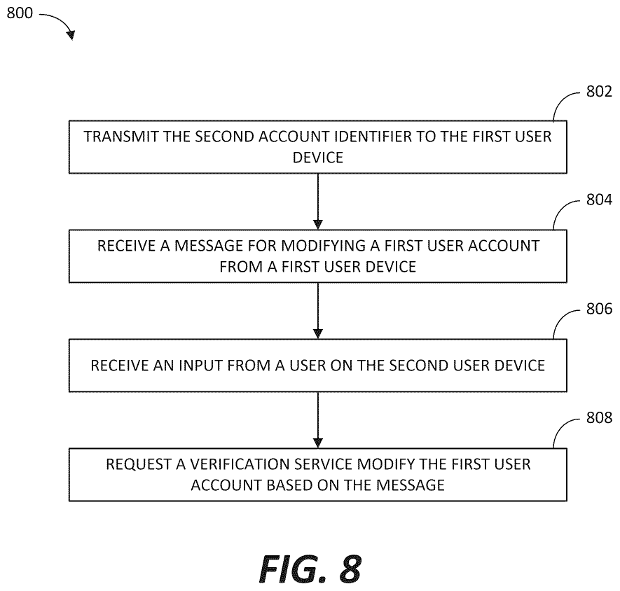

FIG. 8 is a flow diagram of an example process for P2P communication on a receiver device, in accordance with one or more embodiments. For explanatory purposes, the figure is described with reference to the system 100 of FIG. 1 and thus the process 800 may be a computer-implemented method. However, this is merely illustrative, and features of the system 100 may be performed by any other system for implementing the subject technology. Additionally, for explanatory purposes, the operations of the process 800 are described herein as occurring sequentially or linearly. However, multiple operations of the process 800 may occur in parallel. The operations of the process 800 need not be performed in the order shown, and one or more operations of the process 800 need not be performed or can be replaced by other operations.

At operation 802, a receiver device (e.g., user device 104) sends (e.g., transmits) a second account identifier to a sender device (e.g., user device 102). The first account identifier is associated with a user of the sender device, and the second account identifier is associated with a user of the receiver device. The receiver device includes an application or service.

In some embodiments, the application or service may be running in the background of the receiver device and periodically transmitting the second account identifier. The sender device may receive the second account identifier from the receiver device when they are within a threshold distance from each other for a particular communication protocol. The distance may be determined based on a strength of a signal emitted from the receiver device.

In some embodiments, the sender device may be emulating a tag (e.g., via HCE). The information in the virtual tag may be a request that causes the receiver device to launch an application for providing the second account identifier. The sender device may send the request when the devices are within a threshold distance from each other for a particular communication protocol. Sending the second account identifier to the sender device may include populating (e.g., writing to) virtual tag with the second account identifier. The populated virtual tag may be read by the sender device to receive the second account identifier.

At operation 804, the receiver device receives from the sender device a message. The message may be for modifying one or more user accounts. The user accounts may be the account associated with the user of the receiver device and/or the account associated with the user of the sender device. The message may include the receiver account identifier, sender account identifier, the user input, and/or a digital signature of the message contents.

In some embodiments, the sender device and receiver device establish a P2P connection (e.g., via a Wi-Fi Direct or Bluetooth communication protocols). The receiver device may receive the message from the sender device via the connection.

In some embodiments, the sender device emulates a tag (e.g., via HCE) and the receiver operates as a tag reader. The sender device may write the message directly to the virtual tag (e.g., via an APDU communication protocol). The receiver device may read the tag (e.g., via an NFC communication protocol) to retrieve the message and may then process the message accordingly. Alternatively, the receiver device emulates the tag and the sender device writes populates the virtual tag with the message. The receiver device may read the message directly from the virtual tag.

In some embodiments, the application on the receiver device used for processing the message may be running in or brought to the foreground of the application before receiving the message from the sender device.

In some embodiments, the receiver device uses different communication protocols in operations 802 and 804.

At operation 806, the receiver device receives an input from a user indicating an acceptance of the message. If the message is accepted, the receiver device may proceed to operation 808. If the message is not accepted, the receiver device may discard the message.

At operation 808, the receiver may send the verification service a request to modify one or more user accounts based on the message. The message may include one or more account identifiers for accounts that the verification service may modify according to the message (e.g., the user input in the message). The message may also include the digital signature generated by the sender device for the verification service to validate to confirm that the sender device has authorized the requested modification.

FIG. 9 is a block diagram of an example computing system 900. A computing system 900 may be a desktop computer, laptop, smartphone, tablet, or any other electronic device having the ability to execute instructions, such as those stored within a non-transitory computer-readable medium. Furthermore, while described and illustrated in the context of a single computing system 900, those skilled in the art will also appreciate that the various tasks described hereinafter may be practiced in a distributed environment having multiple computing systems 900 linked via a local-or wide-area network in which the executable instructions may be associated with and/or executed by one or more of multiple computing systems 900.

In its most basic configuration, the computing system 900 may include at least one processing unit 902 and at least one memory 904, which may be linked via a bus 906. Depending on the exact configuration and type of computing system environment, memory 904 may be volatile (such as RAM 910), non-volatile (such as ROM 908, flash memory, etc.) or some combination of the two.

Computing system 900 may have additional features and/or functionality. For example, computing system 900 may also include additional storage (removable and/or non-removable) including, but not limited to, magnetic or optical disks, tape drives and/or flash drives. Such additional memory devices may be made accessible to the computing system 900 by means of, for example, a hard disk drive interface 912, a magnetic disk drive interface 914, and/or an optical disk drive interface 916. As will be understood, these devices, which may be linked to the system bus 906, respectively, allow for reading from and writing to a hard drive 918, reading from or writing to a removable magnetic disk 920, and/or for reading from or writing to a removable optical disk 922, such as a CD/DVD ROM or other optical media. The drive interfaces and their associated computer-readable media may allow for the non-volatile storage of computer-readable instructions, data structures, program modules and other data for the computing system 900. Those skilled in the art will further appreciate that other types of computer-readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer-readable (e.g., computer-implemented) instructions, data structures, program modules or other data. Any such computer storage media may be part of computing system 900.

A number of program modules may be stored in one or more of the memory/media devices. For example, a basic input/output system (BIOS 924), containing the basic routines that help to transfer information between elements within the computing system 900, such as during start-up, may be stored in ROM 908. Similarly, RAM 910, hard drive 918, and/or peripheral memory devices may be used to store computer-executable instructions comprising an operating system 926, one or more applications programs 928, other program modules 930, and/or program data 932. Still further, computer-executable instructions may be downloaded to the computing system 900 as needed, for example, via a network connection. The applications programs 928 may include, for example, communication module 110.

An end-user may enter commands and information into the computing system 900 through input devices such as a keyboard 934 and/or a pointing device 936. While not illustrated, other input devices may include a microphone, a joystick, a game pad, a scanner, etc. These and other input devices would typically be connected to the processing unit 902 by means of a peripheral interface 938 which, in turn, would be coupled to bus 906. Input devices may be directly or indirectly connected to processing unit 902 via interfaces such as, for example, a parallel port, game port, firewire, or a universal serial bus (USB). To view information from the computing system 900, a monitor 940 or other type of display device may also be connected to bus 906 via an interface, such as via video adapter 942. In addition to the monitor 940, the computing system 900 may also include other peripheral output devices, not shown, such as speakers and printers.

The computing system 900 may also utilize logical connections to one or more computing system environments. Communications between the computing system 900 and the remote computing system environment may be exchanged via a further processing device, such as a network router 941, that is responsible for network routing. Communications with the network router 941 may be performed via a network interface component 944. Thus, within such a networked environment, e.g., the Internet, wide area network (WAN), local area network (LAN), or other like type of wired or wireless network, it will be appreciated that program modules depicted relative to the computing system 900, or portions thereof, may be stored in the memory storage device(s) of the computing system 900.

The computing system 900 may also include localization hardware 946 for determining a location of the computing system 900. In embodiments, the localization hardware 946 may include, for example, a GPS antenna, an RFID chip or reader, a Wi-Fi antenna, or other computing hardware that may be used to capture or transmit signals that may be used to determine the location of the computing system 900.

While this disclosure has described certain embodiments, it is understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, the subject technology is not limited to the specific details set forth herein and can be practiced using one or more other embodiments. In other instances, well known methods, procedures, components, and circuits have not been described in detail as not to unnecessarily obscure various aspects of the present disclosure. Additionally, in one or more embodiments, structures and components are shown in block diagram form to avoid obscuring the concepts of the subject technology.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It is understood, however, that these terms are to be interpreted as referencing physical manipulations and quantities and are merely convenient labels that should be interpreted further in view of terms commonly used in the art.

Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of any of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

What is claimed is:

1. A computer-implemented method comprising:
generating, by a first user device, a request for a session key from a service, wherein the session key includes a cryptographic key configured to allow secure transmission of information from the first user device to a second user device, wherein the request is generated based on a first device identifier of the first user device and an input received at the first user device from a first user, wherein the first user is associated with a first account identifier, and wherein the first account identifier is associated with the service;
generating, by the first user device, a message to a second user device, wherein the message includes the first account identifier, the input, a second account identifier received from the second user device, and a signature generated based on the session key, wherein the signature includes a cryptographic representation of the message to allow secure verification of the message, and wherein the signature is verifiable by the service with the session key to confirm the message was generated by the first user device;
transmitting the message to the second user device by the first user device while the first user device is within a threshold distance from the second user device; and
causing, by the first user device, the service to modify an account associated with the first account identifier based on the message, in response to transmitting the message to the second user device.

2. The computer-implemented method of claim 1, wherein the second account identifier is received in response to a distance between the first user device and the second user device being within a threshold distance, and the distance is determined by the first user device based on a strength of a signal emitted from the second user device.

3. The computer-implemented method of claim 1, wherein generating the message to the second user device is in response to receiving the second account identifier from the second user device.

4. The computer-implemented method of claim 1, wherein the first user device includes an application running in a foreground of the first user device, the application on the first user device is associated with the first account identifier, the second user device includes another application, and the other application on the second user device is associated with the second account identifier.

5. The computer-implemented method of claim 4, wherein transmitting the message to the second user device causes the other application to run in a foreground of the second user device.

6. The computer-implemented method of claim 1, wherein transmitting the message to the second user device comprises:
writing, with a first communication protocol by the first user device, the message to a remote virtual tag.

7. The computer-implemented method of claim 1, wherein transmitting the message to the second user device comprises:
causing, with a first communication protocol by the first user device, an application to run in a foreground of the second user device; and
populating, with the first communication protocol by the first user device, a local virtual tag with the message to be read with a second communication protocol, wherein the local virtual tag is configured to emulate a tag for wirelessly providing information responsive to proximate devices.

8. The computer-implemented method of claim 1, wherein the second account identifier is received via a first communication protocol of the first user device and the message is transmitted via a second communication protocol of the first user device.

9. The computer-implemented method of claim 1, further comprising receiving, from the service, an indication that the account has been modified in accordance with the input.

10. A first user device associated with a first account identifier, the first user device comprising:
a processor; and
a non-transitory computer-readable medium storing instructions that, when executed by the processor, cause the first user device to perform operations comprising:
determining that a second user device is within a threshold distance of the first user device and, in response, receiving a second account identifier from the second user device, wherein the first account identifier and the second account identifier are associated with respective accounts hosted by a service; and
in response to receiving the second account identifier from the second user device:
generating a cryptographically signed message to the second user device based on a session key and user input on the first user device, wherein the session key is received from the service and is generated based on the user input;
transmitting, to the second user device, the cryptographically signed message, wherein the cryptographically signed message is configured to allow secure communication of information from the first user device to the second user device; and
receiving, from the service, an indication that an account associated with the first account identifier has been modified in accordance with the user input.

11. The first user device of claim 10, wherein the user input includes a numerical value.

12. The first user device of claim 11, wherein the indication includes a total value associated with a first user account, the total value modified by the numerical value.

13. The first user device of claim 10, wherein transmitting the cryptographically signed message to the second user device comprises:
populating, by the first user device with a first communication protocol, a virtual tag on the second user device with the cryptographically signed message.

14. The first user device of claim 10, wherein transmitting the cryptographically signed message to the second user device comprises:
populating, by the first user device with a first communication protocol, a virtual tag on the first user device with the cryptographically signed message, the virtual tag to be read by the second user device with a second communication protocol.

15. The first user device of claim 10, wherein receiving the second account identifier is with a first communication protocol and transmitting the cryptographically signed message is with a second communication protocol.

16. A non-transitory computer-readable medium storing instructions that, when executed by a processor of a first user device, cause the first user device to perform operations comprising:
detecting a second user device within a threshold distance from the first user device and, in response:
requesting a session key from a remote service, the session key including a cryptographic key configured to allow secure transmission of information from the first user device to the second user device;
receiving the session key, wherein the session key is generated based on a set of message contents;
generating a cryptographic signature based on the set of message contents, wherein the cryptographic signature includes a cryptographic representation of the set of message contents to allow secure verification of the set of message contents by the remote service;
transmitting, to the second user device, a message including the set of message contents and the cryptographic signature; and
receiving an indication that an account has been modified in accordance with the set of message contents, wherein the account associated with the remote service and the first user device.

17. The non-transitory computer-readable medium of claim 16, wherein the first user device includes an application running in a foreground of the first user device, and detecting the second user device comprises detecting, by the application, a signal generated by another application running in a background of the second user device.

18. The non-transitory computer-readable medium of claim 16, wherein transmitting the message to the second user device causes an application to run in a foreground of the second user device.

19. The non-transitory computer-readable medium of claim 16, wherein transmitting the message to the second user device comprises:
writing, by the first user device with a first communication protocol, the message to a virtual tag on the second user device.

20. The non-transitory computer-readable medium of claim 16, wherein transmitting the message to the second user device comprises:
populating, by the first user device with a first communication protocol, a virtual tag on the first user device with the message to be read by the second user device with a second communication protocol.
